(19) United States
(12) Patent Application Publication
(10) Pub. No.: US 2025/0378272 A1
(43) Pub. Date: Dec. 11, 2025

(54) DETECTING SURREPTITIOUS SPEECH USING MACHINE LEARNING MODELS

(71) Applicant: X Development LLC, Mountain View, CA (US)

(72) Inventors: Ozan Gokdemir, Chicago, IL (US); Garrett Raymond Honke, Mountain View, CA (US); Jeffrey Bush, Los Altos, CA (US)

(21) Appl. No.: 18/737,324

(22) Filed: Jun. 7, 2024

(51) Int. Cl. G06F 40/284

(52) U.S. Cl. CPC G06F 40/284

(57) ABSTRACT

Methods, systems, and apparatus, including computer programs encoded on computer storage media, for detecting surreptitious speech. One of the methods includes obtaining data representing a sequence of text; obtaining a sequence of tokens for the sequence of text comprising one or more groups of tokens, wherein each group comprises two or more tokens; processing the one or more groups of tokens using a first machine learning model to identify tokens that are out of context in the sequence of tokens; and providing data representing the identified tokens.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations for detecting surreptitious speech from a given sequence of text. For example, the system can detect out-of-context subwords or words in the sequence of text using one or more machine learning models.

In general, one innovative aspect of the subject matter described in this specification can be embodied in methods that include the actions of obtaining data representing a sequence of text; obtaining a sequence of tokens for the sequence of text comprising one or more groups of tokens, wherein each group comprises two or more tokens; processing the one or more groups of tokens using a first machine learning model to identify tokens that are out of context in the sequence of tokens; and providing data representing the identified tokens.

Another innovative aspect of the subject matter described in this specification can be embodied in methods that include the actions of obtaining data representing a sequence of text; dividing the sequence of text into a plurality of segments, wherein each segment comprises a plurality of words or subwords that are semantically relevant; processing the plurality of segments using a second machine learning model to identify segments that include surreptitious language; and providing data representing the identified segments.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination.

In some implementations, the sequence of text represents one or more documents.

In some implementations, obtaining a sequence of tokens for the sequence of text comprises providing the sequence of text as input to a model that is configured to generate a sequence of tokens given an input sequence of text.

In some implementations, each group represents a sentence fragment of the sequence of text.

In some implementations, processing the one or more groups of tokens using a first machine learning model to identify tokens that are out of context in the sequence of tokens comprises: for each group in the one or more groups: for each token in the group: generating an input prompt for the token, wherein the input prompt comprises the two or more tokens of the group and a mask in a location of the token; providing the input prompt to the first machine learning model, wherein the first machine learning model is configured to generate a probability distribution given one or more tokens and a mask, wherein the probability distribution comprises a respective probability that each of a plurality of tokens appears in the location of the mask, and wherein the plurality of tokens includes the tokens; determining that the respective probability for the tokens does not meet a threshold probability; and in response to determining that the respective probability for the token does not meet a threshold probability, identifying the token as out of context.

In some implementations, the threshold probability is obtained from a user.

In some implementations, processing the one or more groups of tokens using a first machine learning model to identify tokens that are out of context in the sequence of tokens comprises processing the one or more groups of tokens using the first machine learning model to identify phrases that are out of context, wherein each phrase comprises two or more consecutive tokens.

In some implementations, processing the one or more groups of tokens using the first machine learning model to identify phrases that are out of context comprises: for each group in the one or more groups: identifying one or more phrases in the group; for each identified phrase: for each token in the identified phrase: generating an input prompt, wherein the input prompt comprises the two or more tokens of the group and a mask in a location of the token; providing the input prompt to the first machine learning model, wherein the first machine learning model is configured to generate a probability distribution given one or more tokens and a mask, wherein the probability distribution comprises a respective probability that each of a plurality of tokens appears in the location of the mask, and wherein the plurality of tokens includes the token; determining a respective probability for the token; determining a combined probability for the identified phrase based on the respective probabilities for the tokens in the identified phrase; determining that the combined probability for the identified phrase does not meet a second threshold probability; and in response to determining that the combined probability for the identified phrase does not meet the second threshold probability, identifying the identified phrase as out of context.

In some implementations, identifying one or more phrases comprises identifying one or more phrases that each comprise two or more consecutive tokens and less than a maximum number of consecutive tokens.

In some implementations, the first machine learning model comprises a language model that has been trained on a masked language modeling task.

In some implementations, the language model comprises an encoder-based transformer.

In some implementations, the method further comprises identifying high-value tokens from the identified tokens.

In some implementations, identifying high-value tokens from the identified tokens comprises: for each of the identified tokens, determining a number of occurrences of the identified token in the sequence of text; and identifying one or more identified tokens with a number of occurrences over a threshold number of occurrences as high-value tokens.

In some implementations, the sequence of text represents one or more documents originating from one or more authors, and wherein identifying high-value tokens from the identified tokens comprises: obtaining one or more authors of interest from the one or more authors; for each of the identified tokens, determining a corresponding set of authors for the identified token; and identifying one or more identified tokens with a corresponding set of authors that includes at least one of the one or more authors of interest as high-value tokens.

In some implementations, processing the plurality of segments using a second machine learning model to identify segments that include surreptitious language comprises: for each segment of the plurality of segments: providing the segment to the second machine learning model, wherein the second machine learning model is configured to generate a score representing a likelihood that an input segment of text includes language that indicates an author of the segment is hiding information; determining that the score for the segment meets a threshold score; and in response to determining that the score for the segment meets the threshold score, identifying the segment as including surreptitious language.

In some implementations, processing the plurality of segments using a second machine learning model to identify segments that include surreptitious language comprises: obtaining a timestamp for each segment in the plurality of segments; determining a temporally ordered sequence of segments for the plurality of segments based on the timestamps for each segment; for each consecutive pair of segments in the temporally ordered sequence: determining an interval of time elapsed between a first segment of the consecutive pair of segments and a second segment of the consecutive pair of segments; determining that the interval of time meets a threshold interval of time; in response to determining that the interval of time meets the threshold interval of time, providing the first segment to the second machine learning model, wherein the second machine learning model is configured to generate a score representing a likelihood that an input segment of text includes language that indicates an author of the segment is hiding information; determining that the score for the first segment meets a threshold score; and in response to determining that the score for the first segment meets the threshold score, identifying the first segment as including surreptitious language.

In some implementations, the threshold interval of time is determined based on an average interval of time elapsed between consecutive segments in the temporally ordered sequence of segments.

Particular embodiments of the subject matter described in this specification can be implemented to realize one or more of the following advantages.

The system described in this specification can detect surreptitious speech in a given sequence of text within limited time constraints (e.g., in less than 1 hour, in less than 30 minutes, in less than 10 minutes, in less than 5 minutes, in less than 3 minutes, or in less than 1 minute after receiving the given sequence of text depending on a variety of factors such as the computing resources being used, the size of the sequence of text, and the amount of parallelization, such as the number of parallel threads processing the documents). For example, the system can use different amounts of computing resources and/or numbers of parallel threads to process different amounts of text over a particular period of time.

Surreptitious speech can include the use of words or phrases that are out of context. Surreptitious speech can include words for which the true meaning is not evident from the words. For example, surreptitious speech can include code words. Surreptitious speech can also include surreptitious language that indicates an author is hiding information, or is about to switch a communication channel. Surreptitious speech is often used to hide the commission of a crime, for example, in written communication. In proceedings such as a legal discovery process, surreptitious speech can be used to bring forth evidence of a crime.

Conventionally, detecting surreptitious speech may require manually searching through documents, which may consume a large amount of time and resources. The amount of text or the number of documents may be extremely large. For example, a discovery process may involve hundreds or thousands of documents. The system described in this specification can detect surreptitious speech over a large number of documents within a limited time constraint, such as in preparation for a deposition.

In some implementations, the system described in this specification can detect surreptitious speech for different levels of surreptitiousness. For example, the system can use a machine learning model to determine a probability for a particular token, e.g., word or subword, in the sequence of text. The system can flag a token as surreptitious if the probability it assigns to that token of naturally appearing in the text is lower than a user-adjusted threshold. For example, the system can determine that the token is out of context if the probability does not meet a threshold probability. The threshold probability can be variable. For example, the threshold probability can be user-defined or adjusted. For example, if the threshold probability is higher, the system may identify fewer tokens as being out of context, raising the standard for what is “surreptitious,” and decreasing the risk of identifying false positives. If the threshold probability is lower, the system may identify more tokens as being out of context, lowering the standard for what is “surreptitious,” and decreasing the risk of missing true positives.

The system described in this specification can detect surreptitious speech that is robust to typos and misspellings. A misspelled word in a particular location may have a low probability in a probability distribution over a vocabulary of words (the probability distribution describing the probability that a word appears in the particular location) or not appear in the distribution at all. Although the misspelled word has a low probability of being in that location, it may not be surreptitious. The system processes tokens that represent words or subwords, rather than words, making the system more robust to misspelled words. A misspelled word in a particular location can be made up of multiple subwords, of which one or more subwords are spelled correctly. The system uses probability distributions that describe the probability that a subword appears in the particular location, over a vocabulary of subwords. Each subword is more likely to be found in the vocabulary of subwords.

In some implementations, the system described in this specification can further refine the out of context tokens by identifying high-value tokens. Identifying high-value tokens can indicate prioritization for downstream processing tasks. A high-value token can be a token that is repeated. For example, repetition can indicate that the token has a particular meaning or importance. A high-value token can also be a token that originates from authors of interest. For example, the authors of interest may include a party in a lawsuit of the discovery process, or individuals with particular titles. The system can thus provide an indication that particular tokens merit particular scrutiny, making further processing more focused and efficient.

In some implementations, the system can also detect out of context phrases that include more than one token. For example, a phrase such as “taking a bath” includes more than one token. The system can determine a combined probability for the phrase. The system can thus determine both out of context tokens and out of context phrases.

In some implementations, the system can also detect segments including surreptitious language. For example, segments including surreptitious language can include speech that indicates the authors are hiding their channels of communication. Segments including surreptitious language can also be used as evidence that the opposing party did not produce all relevant documents. The system can divide the sequence of text into segments, and use a machine learning model to determine whether a segment includes surreptitious language.

In some implementations, the system can use the timing of the segments to detect segments including surreptitious language. For example, a break in communication can indicate a switch to a different communication medium, which may indicate a need for further requests for discovery. More specifically, the system can determine an interval of time typically elapsed between consecutive communication segments (e.g., communications between two parties of interest) and determine whether the interval of time between two particular consecutive segments meets a threshold interval of time, e.g., double the typical or average interval of time. If the threshold interval of time is met, the system can provide the first segment of the two particular consecutive segments to a machine learning model to determine whether the first segment includes surreptitious language.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for detecting surreptitious speech.

FIG. 2 is a flow chart of an example process for detecting surreptitious speech.

FIG. 3 is a flow chart of an example process for identifying tokens that are out of context.

FIG. 4 is a flow chart of an example process for identifying phrases that are out of context.

FIG. 5 shows another example system for detecting surreptitious speech.

FIG. 6 is a flow chart of another example process for detecting surreptitious speech.

FIG. 7 depicts a schematic diagram of a computer system that may be applied to any of the computer-implemented methods and other techniques described herein.

Like reference numbers and designations in the various drawings indicate like elements.

### DETAILED DESCRIPTION

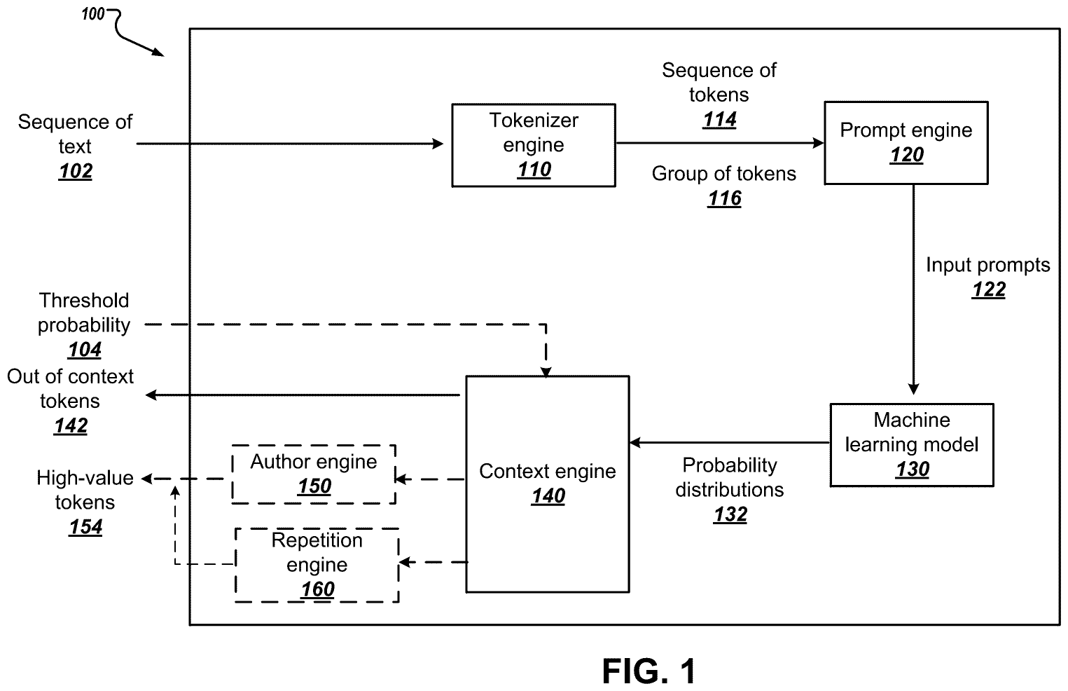

FIG. 1 shows an example system 100 for detecting surreptitious speech. The system 100 is an example of a system implemented as computer programs on one or more computers in one or more locations. The system 100 can include a tokenizer engine 110, a prompt engine 120, a machine learning model 130, a context engine 140, and optionally, an author engine 150 and a repetition engine 160. In some implementations, the components can be part of a same system and/or network of computing devices and/or systems.

The tokenizer engine 110 can be any appropriate computing system that is configured to generate a sequence of tokens given an input sequence of text. Each token can represent a unit of text such as a word or subword. Each subword can include a part of a word. For example, the tokenizer engine 110 can generate a sequence of tokens 114 from the sequence of text 102. As an example, the tokenizer engine 110 can be a Byte Pair Encoder (BPE) or a SentencePiece tokenizer.

The sequence of text 102 can include one or more documents. For example, the one or more documents can include communication records such as e-mails, letters, or transcripts. Although this specification relates to sequences of text that are relevant to the discovery process, the system 100 can be used to detect surreptitious speech for many types of sequences of text.

In some examples, the system can divide the sequence of tokens 114 into one or more groups of tokens 116. For example, each group of tokens 116 can include a predetermined number of tokens. For example, the predetermined number can be the context window for the machine learning model 130. As another example, each group of tokens 116 can represent a sentence fragment. Each sentence fragment can include at least part of a sentence. Each sentence fragment can include multiple tokens. For example, the system 100 can divide the sequence of text 102 into sentence fragments.

The prompt engine 120 can be any appropriate computing system that is configured to generate prompts. For example, the prompt engine 120 can generate input prompts 122 for the group(s) of tokens 116. In particular, the prompt engine 120 can generate an input prompt 122 for each token in each group of tokens of the sequence of tokens 114. Each input prompt 122 can include tokens of a particular group of tokens and a mask in the location of one of the tokens of the group. Each mask can be identified by a particular word or special token, and take the place of a token in the particular group.

As an example, a group of tokens 116 can include “Please manage Chewco.” The tokens can represent the subwords “please,” “manage,” and “Chewco.” The input prompts 122 corresponding to the group can include tokens that represent: “[MASK] manage Chewco.”, “Please [MASK] manage Chewco.”, and “Please manage [MASK].”

The machine learning model 130 can be any appropriate computing system that is configured to generate a probability distribution for a mask given one or more tokens and the mask. Each probability distribution can correspond to an input prompt that includes a mask. The probability distribution can include a probability that each token in a vocabulary would appear in the location of the mask in the context of the one or more tokens. For example, the machine learning model 130 can generate probability distributions 132 for the input prompts 122.

The machine learning model 130 can be a language model neural network, for example. The machine learning model 130 can be a Transformer-based model. The machine learning model 130 can be a bidirectional encoder. For example, the machine learning model 130 can be a pre-trained BERT model. The machine learning model 130 can have been trained or fine-tuned on a masked language modeling task. In some examples, the tokenizer engine 110 is part of the machine learning model 130.

The context engine 140 can be any appropriate computing system that is configured to determine whether the probability for a token meets a threshold probability given a probability distribution. For example, for each prompt, the context engine 140 can receive a probability distribution 132 for the particular group and particular token of the prompt. For each particular token in each group, the context engine 140 can determine the probability for the particular token in the corresponding probability distribution 132.

As an example, the context engine 140 can determine that the probability for the particular token is above a threshold probability 104, that is, the probability that the particular token appeared in the location that it did in the group is high enough that its appearance is not surreptitious. As another example, the context engine 140 can determine that the probability for the particular token is below the threshold probability 104, that is, the probability that the particular token appeared in the location that it did in the group is low enough that its appearance is surreptitious. In response, the context engine 140 can identify the particular token as out of context.

In some implementations, the context engine 140 can determine whether a phrase of multiple tokens meets a threshold probability given probability distributions corresponding to the multiple tokens. For example, the context engine 140 can determine a combined probability for the phrase based on the probabilities for the tokens. The context engine 140 can identify the phrase as out of context if the combined probability is below a threshold probability.

In some implementations, the threshold probability 104 can be a default value. For example, the threshold probability 104 can be the lowest 8^{th}, 6^{th}, 5^{th}, 4^{th}, or 3^{rd} percentile in the probability distribution. In some implementations, the system 100 can receive the threshold probability 104 from a user. In some implementations, the threshold probability 104 can be determined by the system 100.

As an example, the system 100 can obtain a sequence of text 102. The system 100 can use the tokenizer engine 110 to obtain a sequence of tokens 114 from the sequence of text 102. In some examples, the system 100 can divide the sequence of tokens 114 into one or more groups of tokens 116. The system can use the prompt engine 120 to generate input prompts 122 for each token in each group of the groups of tokens 116. The system 100 can provide the input prompts 122 to the machine learning model 130 to generate probability distributions 132. Each probability distribution can correspond to a particular token in a particular group. The system 100 can provide the probability distributions 132 to the context engine 140. For each token and corresponding probability distribution, the context engine 140 can determine whether the token is out of context according to the probability distribution. The system 100 can output data representing the unique out of context tokens 142. For example, the system 100 can output the words or subwords represented by the out of context tokens 142 as out of context words or subwords.

In some implementations, the system 100 can identify high-value tokens 154 from the out of context tokens 142. High-value tokens 154 can include tokens that are out of context and occur often within the sequence of text 102, and/or represent words or subwords that were written by, or said by, an author of interest. Identifying an out of context token 142 as a high-value token 154 can indicate for a downstream processing task or to a user that the subword or word represented by the token may be particularly surreptitious. Identifying high-value tokens can provide for an additional layer of filtering for surreptitious speech. The system 100 can output data representing the high-value tokens 154. For example, the system 100 can output the words or subwords represented by the high-value tokens 154.

For example, in these implementations, the system 100 can include a repetition engine 160. The repetition engine 160 can be any appropriate computing system that is configured to determine a number of occurrences for a given token in the sequence of text 102. For example, for each out of context token 142, the repetition engine 160 can process the sequence of text 102 or the sequence of tokens 114 to determine the number of occurrences of the token. The repetition engine 160 can identify out of context tokens 142 that have a number of occurrences over a threshold number of occurrences as a high-value token 154.

As another example, the system 100 can include an author engine 150. The author engine 150 can be any appropriate computing system that is configured to determine a set of authors for a given word or subword represented by a given token. For example, for each out of context token 142, the author engine 150 can determine a corresponding set of authors for the word or subword represented by the token. The author engine 150 can identify an out of context token 142 as a high-value token if the corresponding set of authors includes an author of interest. For example, an author of interest can be an author of more than a threshold number of the out of context token instances.

In some implementations, the system 100 can include a user interface. The user interface can be configured to allow a user to interact with the system 100. For example, the user interface can allow a user to input a sequence of text 102 and receive data representing out of context tokens 142 from the system 100. In some implementations, the user interface can allow a user to input a threshold probability 104 and/or to receive data representing high-value tokens 154.

In some implementations, the system 100 can output data representing the set of out of context tokens 142 or the high-value tokens 154 in the context of the sequence of text 102. For example, the system 100 can provide the sequence of text 102 for display to the user, with the words or subwords represented by the out of context tokens 142 or the high-value tokens 154 highlighted. In some implementations, the system 100 can provide a ranking of how surreptitious the out of context tokens 142 or the high-value tokens 154 are. For example, the system 100 can assign a higher ranking to high-value tokens 154 or out of context tokens 142 that have lower probabilities in the corresponding probability distributions, and present the tokens with higher rankings to the user earlier for prioritization.

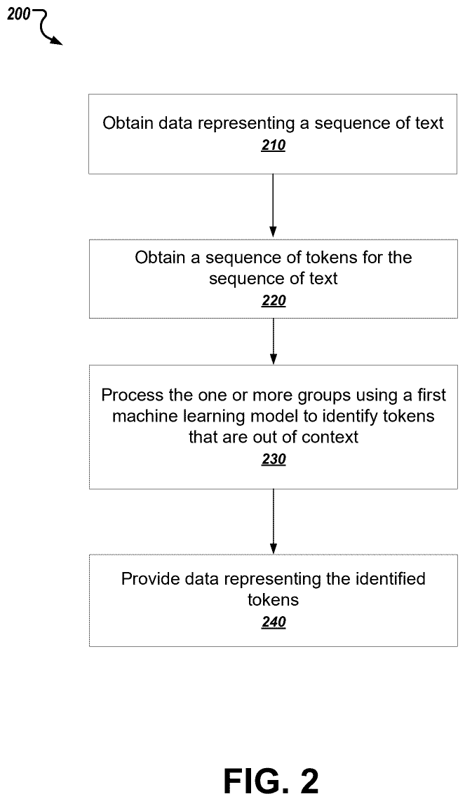

FIG. 2 is a flow chart of an example process 200 for detecting surreptitious speech. For convenience, the process 200 will be described as being performed by a system of one or more computers located in one or more locations. For example, a system for detecting surreptitious speech, e.g., the system 100 of FIG. 1, appropriately programmed in accordance with this specification, can perform the process 200.

The system obtains data representing a sequence of text (step 210). The sequence of text can represent one or more documents. For example, the documents can include records of communication. In some implementations, the system can receive the data from a user.

The system divides the sequence of text into multiple tokens (step 220). Each token can represent a word or a subword using an identifier such as an integer. Each token can be part of a vocabulary of tokens. For example, the system can provide the sequence of text as input to a model that is configured to generate a sequence of tokens given an input sequence of text. For example, the model can be the tokenizer engine 110 of FIG. 1.

The tokens in the vocabulary can be any appropriate text tokens, e.g., words, word pieces, punctuation marks, characters, bytes, and so on that represent elements of text in one or more natural languages and, optionally, numbers and other text symbols that are found in a corpus of text.

The sequence of tokens can include one or more groups of tokens. For example, the system can divide the sequence of tokens into one or more groups. Each group includes two or more tokens. For example, the system can divide the sequence of tokens into groups that include a number of tokens that is less than or equal to a context window for the first machine learning model. For example, each large language model can have a context window that defines the number of tokens the large language model can receive as input.

In some examples, each group can represent a sentence fragment. For example, the system can divide the sequence of text into sentence fragments. Each sentence fragment includes two or more tokens. For example, the system can provide the sequence of text as input to a model that is configured to generate multiple sentence fragments given an input sequence of text. The system can divide the sequence of tokens into groups of tokens that each represent a sentence fragment.

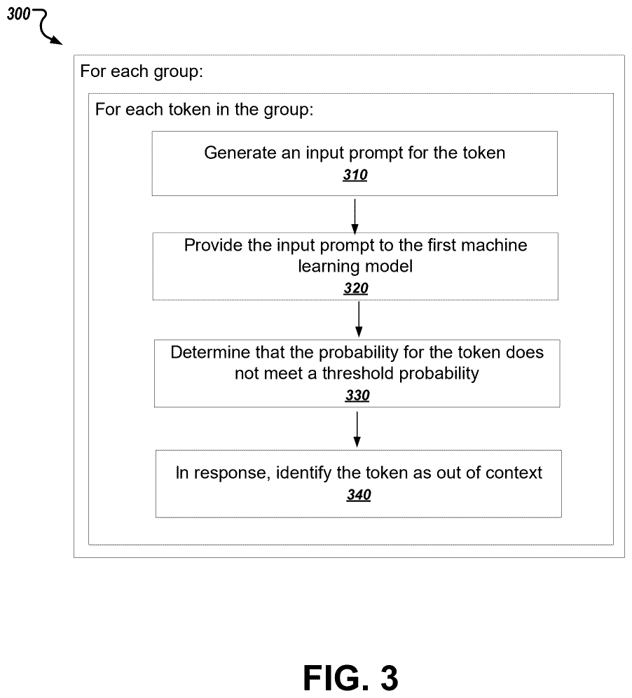

The system processes the one or more groups using a first machine learning model to identify tokens that are out of context (step 230). For example, the system can process the one or more groups using a prompt engine, a first machine learning model, and a context engine. More specifically, the system can use the prompt engine 120, the machine learning model 130, and the context engine 140 of FIG. 1 to identify tokens that are out of context in the sequence of tokens. Processing the tokens to identify tokens that are out of context is described in further detail below with reference to FIG. 3.

The first machine learning model can include a language model that has been trained on a masked language modeling task. In some implementations, the language model can include an encoder-based transformer. In some implementations, the language model can include a bidirectional encoder.

Language models are machine learning models that can employ one or more layers of nonlinear units to predict an output for a received input. For example, the language model can have any appropriate neural network architecture that allows the model to map an input sequence of text tokens from a vocabulary to an output sequence of text tokens from the vocabulary.

The system provides data representing the identified tokens (step 240). For example, the system can provide data representing the subwords or words represented by the identified tokens to a user through a user interface.

In some implementations, the system can identify high-value tokens from the identified tokens.

For example, a high-value token can be an identified token that also occurs often in the sequence of text. For example, the system can use the repetition engine 160 of FIG. 1 to identify high-value tokens. In these implementations, the system can, for each of the identified tokens, determine a number of occurrences of the identified token in the sequence of text. The system can identify the identified token as a high-value token if the number of occurrences of the identified token is over a threshold number of occurrences. The system can also provide data representing the number of occurrences of the identified token.

The threshold number of occurrences can be a default value. In some implementations, the system can receive the threshold number of occurrences from a user. In some implementations, the system can determine the threshold number of occurrences based on a total number of tokens in the sequence of text, a total number of identified tokens, and/or the number of occurrences of each of the identified tokens. For example, if the number of tokens in the sequence of text is very large, identified tokens with a small number of occurrences may be false positives. As another example, if the total number of identified tokens is very large, identified tokens with a small number of occurrences may be false positives. As another example, if some of the identified tokens have a large number of occurrences, identified tokens with a small number of occurrences may be false positives. The system can thus tailor the threshold number of occurrences based on the sequence of text.

As another example, a high-value token can be an identified token originating from an author of interest. The system can use the author engine 150 of FIG. 1 to identify high-value tokens. For example, the sequence of text can represent one or more documents originating from one or more authors. The documents can be written by the one or more authors, or transcriptions of what was said by the one or more authors. The system can obtain one or more authors of interest of the one or more authors. As an example, in a discovery process in a suit between parties that have multiple associated individuals, the authors of interest can be the individuals associated with one of the parties.

In some implementations, the system can receive data identifying the authors of interest from a user. For example, authors of interest can be particular individuals or have particular titles. In some implementations, the system can identify one or more of the authors as authors of interest, for example, based on a frequency of communications originating from the authors. For example, an author of interest may be a relatively active communicator compared to the other authors of the documents. As another example, an author of interest may be an author of more than a threshold number of instances of one or more of the words or subwords represented by the identified tokens.

For each of the identified tokens, the system can determine a corresponding set of authors for the word or subword represented by the identified token. The corresponding set of authors for the identified token can include one or more authors. For example, for each identified token, the system can identify all of the documents that include the token. For each of the identified documents, the system can determine the author of the document. For example, the system can determine the author from the text of the document. For example, the system can determine the author from email signatures, or other text of the document that indicates the sender or author of the document. The system can also determine the author from metadata of the document. The system can include all of the authors that have used the word or subword represented by the identified token in the corresponding set of authors for the identified token.

The system can identify one or more identified tokens with a corresponding set of authors that includes at least one of the one or more authors of interest as high-value tokens. For example, if a corresponding set of authors for an identified token includes one of the authors of interest, the system can identify the token as a high-value token.

In some implementations, the system can identify one or more identified tokens with a corresponding set of authors that includes a large proportion of all of the authors involved in the sequence of text as a high-value token. A large proportion of authors using the same word or subword represented by the out of context token may indicate a larger-scale surreptitious activity. For example, the system can determine that the corresponding set of authors includes greater than a threshold proportion of all of the authors involved in the sequence of text.

FIG. 3 is a flow chart of an example process 300 for identifying tokens that are out of context. For convenience, the process 300 will be described as being performed by a system of one or more computers located in one or more locations. For example, a system for detecting surreptitious speech, e.g., the system 100 of FIG. 1, appropriately programmed in accordance with this specification, can perform the process 300 as part of step 230 described with reference to FIG. 2.

The system performs steps 310-340 for each group and for each token in the group. The system generates an input prompt for the token (step 310). The input prompt can include the tokens of the group and a mask in a location of the token. The system can use the prompt engine 120 of FIG. 1 to generate the input prompt. The mask can replace the token in the group. For example, the group can include tokens that represent “Please manage Chewco.” The input prompt for the token that represents “Chewco” can include tokens that represent “Please manage [MASK].”

The system provides the input prompt to the first machine learning model (step 320). The first machine learning model can be configured to generate a probability distribution given one or more tokens and a mask. The probability distribution can include a respective probability that each of multiple tokens appears in the location of the mask. The multiple tokens can include the token.

The first machine learning model can be a language model. The multiple tokens can be part of a vocabulary of tokens, for example, that the language model was trained on. The probability distribution can be generated based on the logits of the last layer of the language model, for example.

The system determines that the probability for the token does not meet a threshold probability (step 330). For example, the system can determine the probability for the token from the probability distribution. The system can determine that the probability for the token in the probability distribution is below the threshold probability. The system can use the context engine 140 of FIG. 1 to determine that the probability for the token does not meet a threshold probability, for example.

In some examples, the probability distribution may not include the token. The system can assign a default probability, such as a probability of zero, to the token.

In some implementations, the system can obtain the threshold probability from a user. In some implementations, the threshold probability can be adjusted. For example, the user can provide different threshold probabilities to the system, obtain the different sets of identified tokens from the system, change the threshold probabilities, and obtain new sets of identified tokens from the system in order to capture more tokens or fewer tokens.

In some implementations, the threshold probability can be a default probability. In some implementations, the threshold probability can be dependent on the types of documents in the sequence of text. For example, the threshold probability can be dependent on the industry or the topics of the documents.

In some implementations, the system can determine the threshold probability. For example, the system can sort the probabilities of the probability distribution from the lowest to highest probability. The system can fit a Cumulative Distribution Function (CDF) to the sorted probability distribution. The system can determine the probability of the sorted probability distribution at which a threshold percentage of probabilities is met. For example, the threshold percentage can be the lowest 10% of probabilities, or the lowest 5% of probabilities. The system can assign the threshold probability to be the probability at which the threshold percentage of probabilities are less probable than the threshold probability. For example, the threshold probability can be the probability at which 10%, or 5%, of probabilities in the probability distribution, are smaller than the threshold probability.

As another example, the threshold probability can be set based on a benchmark set. For example, the system can obtain a benchmark set that includes one or more tokens that were identified as out of context from a subset of the sequence of text. The system can obtain the benchmark set from a user input. For example, the system can receive an input from the user that includes one or more words or subwords. The system can obtain tokens to include in the benchmark set that each represent a words or subword of the input from the user. The desired threshold probability can be the threshold probability that, when the system processes the sequence of text to identify out of context tokens, results in identified tokens that match the benchmark set.

The system can determine the desired threshold probability iteratively. For example, the system can obtain a set of identified tokens corresponding to a particular threshold probability by performing the process 300 for the sequence of text. The system can compare the set of identified tokens corresponding to the particular threshold probability to the benchmark set. If the set of identified tokens corresponding to the particular threshold probability differs from the benchmark set, the system can update the particular threshold probability. For example, the system can increase or decrease the particular threshold probability by a predetermined amount. The system can obtain a set of identified tokens corresponding to the updated particular threshold probability, and compare the set of identified tokens corresponding to the updated particular threshold probability to the benchmark set. If the set of identified tokens corresponding to the updated particular threshold probability differs from the benchmark set, the system can further update the particular threshold probability. The system can repeat the steps of updating the particular threshold probability and obtaining a set of identified tokens corresponding to the particular threshold probability until the set of identified tokens matches the benchmark set. The system can determine that the desired threshold probability is the particular threshold probability that corresponds to a set of identified tokens that matches the benchmark set.

In some examples, none of the particular threshold probabilities may correspond to sets of identified tokens that match the benchmark set. For example, the corresponding sets of identified tokens may be missing a token, have an extra token, or have a different token compared to the benchmark set. The system can determine that the desired threshold probability is the particular threshold probability that corresponds to a set of identified tokens that is most similar to the benchmark set. For example, the set of identified tokens that is most similar to the benchmark set may have the fewest differences when compared to the benchmark set.

As another example, the benchmark set can include a certain number of tokens, or a benchmark number of tokens. The desired threshold probability can be the threshold probability that, when the system processes the sequence of text to identify out of context tokens, results in the same number of identified tokens as the benchmark set.

The system can determine the desired threshold probability iteratively. For example, the system can obtain a set of identified tokens corresponding to a particular threshold probability by performing the process 300 for the sequence of text. The system can compare the number of tokens in the set of identified tokens corresponding to the particular threshold probability to the benchmark number. If the number of tokens in the set of identified tokens corresponding to the particular threshold probability differs from the benchmark number, the system can update the particular threshold probability. For example, the system can increase or decrease the particular threshold probability by a predetermined amount. The system can obtain a set of identified tokens corresponding to the updated particular threshold probability, and compare the number of tokens in the set of identified tokens corresponding to the updated particular threshold probability to the benchmark number. If the number of tokens in the set of identified tokens corresponding to the updated particular threshold probability differs from the benchmark number, the system can further update the particular threshold probability. The system can repeat the steps of updating the particular threshold probability and obtaining a set of identified tokens corresponding to the particular threshold probability until the number of tokens in the set of identified tokens matches the benchmark number. The system can determine that the desired threshold probability is the particular threshold probability that corresponds to a set of identified tokens with a number of tokens that matches the benchmark number.

In some examples, none of the particular threshold probabilities may correspond to sets of identified tokens with a number of tokens that match the benchmark number. For example, the corresponding sets of identified tokens may be missing one or more tokens, or have one or more extra tokens. The system can determine that the desired threshold probability is the particular threshold probability that corresponds to a set of identified tokens with a number of tokens that is closest to the benchmark number.

In response to determining that the probability for the token does not meet a threshold probability, the system identifies the token as out of context (step 340). The system can proceed with step 240 of FIG. 2.

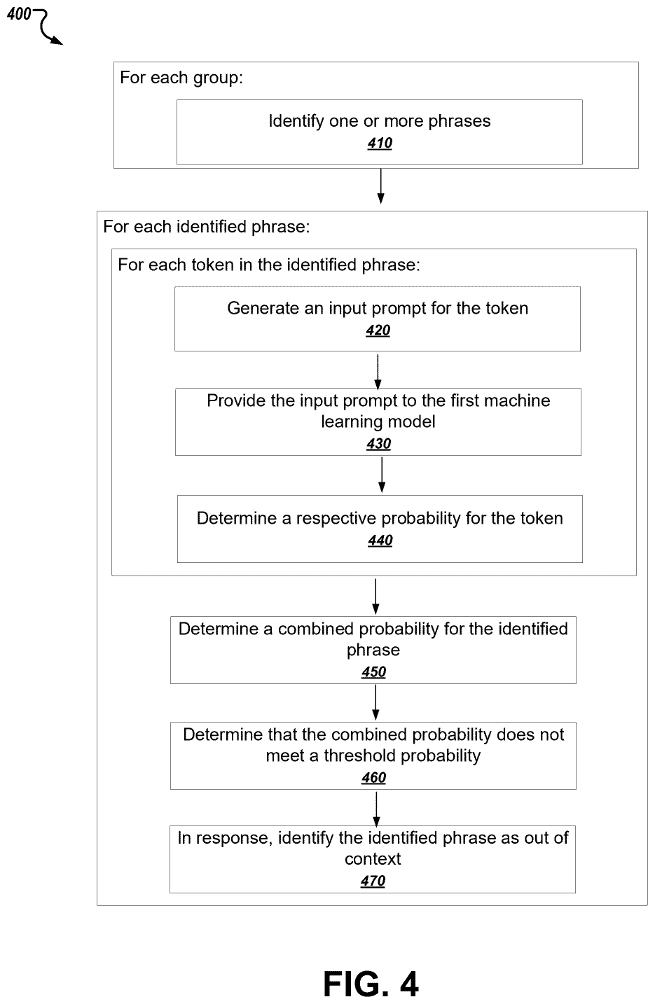

In some implementations, the system can, alternatively or in addition, identify phrases that are out of context, as described with reference to FIG. 4.

FIG. 4 is a flow chart of an example process 400 for identifying phrases that are out of context. For convenience, the process 400 will be described as being performed by a system of one or more computers located in one or more locations. For example, a system for detecting surreptitious speech, e.g., the system 100 of FIG. 1, appropriately programmed in accordance with this specification, can perform the process 400 as part of step 230 described with reference to FIG. 2.

In some implementations, the system can identify phrases that are out of context. Each phrase can include two or more consecutive tokens. For example, processing the sequence of tokens using a first machine learning model to identify tokens that are out of context in the sequence of tokens as described in step 230 can include processing the one or more groups of tokens using the first machine learning model to identify phrases that are out of context.

For each group, the system identifies one or more phrases in the group (step 410). For example, each phrase can include two more consecutive tokens and less than a maximum number of consecutive tokens. The maximum number of consecutive tokens can be a default value, for example 3, 5, 8, 10, 12 or 15, or obtained from a user.

For each identified phrase, for each token in the identified phrase, the system can perform steps 420-440. The system can generate an input prompt (step 420). The input prompt can include the tokens of the group and a mask in the location of the token.

The system can provide the input prompt to the first machine learning model (step 430). The first machine learning model is described above with reference to FIG. 3. The system can generate a probability distribution for the input prompt.

The system can determine a respective probability for the token (step 440). For example, the system can determine the respective probability for the token from the probability distribution.

For each identified phrase, the system can determine a combined probability for the identified phrase (step 450). For example, the system can determine the combined probability based on the probabilities for each of the tokens in the identified phrase. For example, the system can multiply the probabilities for each of the tokens together to determine the combined probability.

For each identified phrase, the system can determine that the combined probability for the identified phrase does not meet a threshold probability (step 460). The threshold probability can be the same threshold probability for identifying out of context tokens, or a threshold probability for identifying out of context phrases. For example, the system can determine that the probability for the phrase is below the threshold probability.

For each identified phrase, in response to determining that the combined probability for the identified phrase does not meet a threshold probability, the system can identify the identified phrase as out of context (step 470). The system can thus identify code phrases or code words that include multiple tokens as surreptitious.

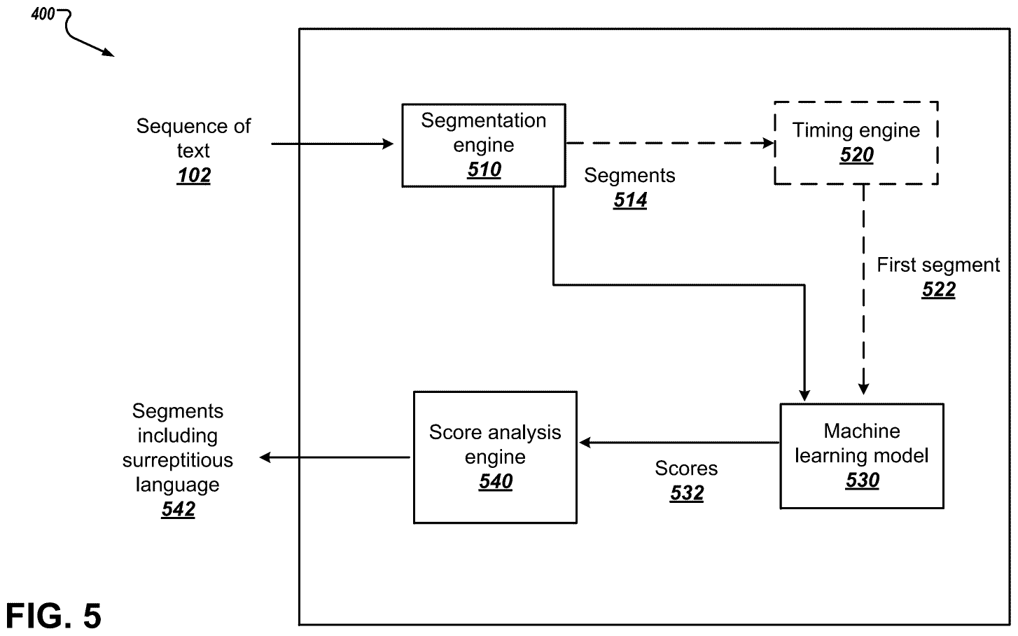

FIG. 5 shows another example system 500 for detecting surreptitious speech. The system 500 is an example of a system implemented as computer programs on one or more computers in one or more locations. The system 500 can include a segmentation engine 510, a machine learning model 530, a score analysis engine 540, and optionally, a timing engine 520. In some implementations, the components can be part of a same system and/or network of computing devices and/or systems.

The segments including surreptitious language 542 can be examples of surreptitious speech, or speech that indicates the authors are hiding their channels of communication. Segments including surreptitious language 542 can also be used as evidence that the opposing party did not produce all relevant documents. For example, the surreptitious language may include suggestions for an alternative channel of communication. The alternative channel of communication may have associated records that were not produced during discovery.

The segmentation engine 510 can be any appropriate computing system that is configured to divide a given sequence of text into segments. The sequence of text can include communication records with multiple authors, for example. Each segment can include multiple words or subwords that are semantically relevant. For example, the segmentation engine can generate segments 514 from the sequence of text 102.

The machine learning model 530 can be any appropriate computing system that is configured to generate a score representing a likelihood that an input segment of text includes language that indicates an author of the segment is hiding information. For example, the machine learning model 530 can be a large language model. For example, the system can provide each segment of segments 514 to the machine learning model 530 to generate scores 532.

The score analysis engine 540 can be any appropriate computing system that is configured to determine whether a score for a segment meets a threshold score. For example, the score analysis engine 540 can receive the scores 532 and identify segments including surreptitious language 542.

As an example, the system 500 can obtain a sequence of text 102. The system 500 can use the segmentation engine 510 to divide the sequence of text 102 into multiple segments 514. The system 500 can use the machine learning model 530 to generate scores 532. The system 500 can use the score analysis engine 540 to identify segments including surreptitious language 542 from the scores 222 for the segments 514. The system 500 can output the segments including surreptitious language 542.

In some implementations, the system 500 can identify segments as including surreptitious language based on the timing of the segments. For example, the system 500 can use the timing engine 520 to identify a first segment 522 that has a large temporal separation from the following segment. A segment that has a large temporal separation from the following segment may indicate a change in communication medium or communication channel. The system 500 can provide the first segment 522 to the machine learning model 530 (in some implementations, the system can also provide the second segment to the machine learning model).

In some implementations, the system 500 can include a user interface. The user interface can be configured to allow a user to interact with the system 500. For example, the user interface can allow a user to input a sequence of text 102 and receive segments including surreptitious language 542 from the system 500.

In some implementations, the system 500 can provide the segments including surreptitious language 542 to the system 100 of FIG. 1. For example, the system 100 can process the segments including surreptitious language 542 as the input sequence of text, and identify out of context tokens 142 that are found in the segments including surreptitious language 542. The system 100 can thus identify out of context tokens 142 focused on the segments that include surreptitious language 542 identified by the system 500.

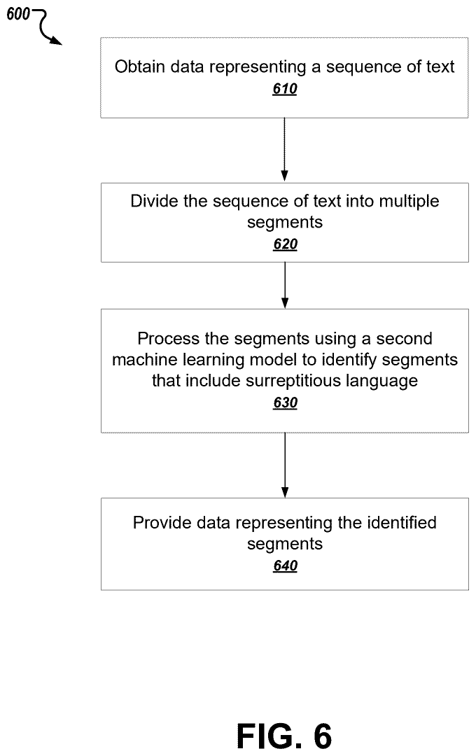

FIG. 6 is a flow chart of another example process 600 for detecting surreptitious speech. For convenience, the process 600 will be described as being performed by a system of one or more computers located in one or more locations. For example, a system for detecting surreptitious speech, e.g., the system 500 of FIG. 5, appropriately programmed in accordance with this specification, can perform the process 600.

The system obtains data representing a sequence of text (step 610). The sequence of text can represent one or more documents. For example, the system can receive the data from a user.

The system divides the sequence of text into multiple segments (step 620). Each of the segments can include multiple words or subwords that are semantically relevant. The system can use the segmentation engine 510 of FIG. 5, for example.

The system processes the segments using a second machine learning model to identify segments that include surreptitious language (step 630). For example, for each segment, the system can provide the segment to the second machine learning model. The second machine learning model can be configured to generate a score representing a likelihood that an input segment of text includes language that indicates an author of the segment is hiding information.

The second machine learning model can be the machine learning model 530 of FIG. 5, for example. In some implementations, the second machine learning model is a large language model.

For example, the system can provide a prompt that includes the segment and a natural language query to generate a likelihood that the author of the segment is hiding information to the second machine learning model.

In some implementations, the system can provide multiple prompts for each segment. For example, for each prompt, the system can provide the segment and a different natural language query about whether the author of the segment is hiding information to the second machine learning model. For example, the outputs can each include a natural language response or a numerical likelihood. The system can aggregate the outputs from the second machine learning model to generate one combined score representing the likelihood that the author of the segment is hiding information.

In some implementations, the large language model can be trained or fine-tuned to generate a score representing a likelihood that an input segment of text includes language that indicates an author of the segment is hiding information. For example, the training data can include training examples of an input segment of text and a ground-truth output representing the score for the input segment of text.

The system can determine that the score meets a threshold score. In response to determining that the score meets the threshold score, the system can identify the segment as including surreptitious language.

The system provides data representing the identified segments (step 640). For example, the system can provide the data to a user through a user interface.

In some implementations, processing the segments to identify segments that include surreptitious language (such as language surreptitiously suggesting using another channel of communication) can include identifying segments that precede a period of time without communication. A period of time without communication that is longer than a threshold period of time, or longer than the usual period of time between communication, can indicate a break in communication. The break in communication can indicate a change in communication medium to hide information.

For example, the system can obtain a timestamp for each segment in the segments 514. For example, the system can obtain the timestamps from metadata for documents from the sequence of text, or from the text of the documents. The system can determine a temporally ordered sequence for the segments 514 based on the timestamps for each segment. For example, the temporally ordered sequence can include a segment A on Monday, a segment B on Tuesday, and a segment C on Friday of the same week.

For each consecutive pair of segments in the temporally ordered sequence, the system can determine an interval of time elapsed between a first segment of the consecutive pair of segments and a second segment of the consecutive pair of segments. The system can determine that the interval of time meets a threshold interval of time. In response to determining that the interval of time meets the threshold interval of time, the system can use the second machine learning model to identify whether the first segment includes surreptitious language (e.g., suggesting an alternative channel of communication such as an encrypted communication channel or non-written communication).

In some implementations, the threshold interval of time can be obtained from a user. In some implementations, the system can determine the threshold interval of time based on an average or typical interval of time elapsed between consecutive segments in the temporally ordered sequence of segments. For example, the average interval of time can indicate a regular pattern of communication. An interval of time greater than the average interval of time can indicate a break in the regular pattern of communication.

For example, the interval of time between segment A and segment B is one day, and the interval of time between segment B and segment C is three days. The threshold interval of time may be two days, for example. The system can thus determine that the interval of time for the pair of segments that includes segment B and segment C is greater than the threshold interval of time and thus meets the threshold interval of time.

The system can use the second machine learning model to identify whether the first segment includes surreptitious language similarly to step 630 of FIG. 6. For example, the system can provide the first segment to the second machine learning model. The system can determine that the score for the first segment generated by the second machine learning model meets the threshold score. In response to determining that the score for the first segment meets the threshold score, the system can identify the first segment as including surreptitious language. For example, the system can provide segment B to the second machine learning model to obtain a score for segment B. The system can determine that the score for segment B is greater than the threshold score and thus meets the threshold score. The system can then identify segment B as including surreptitious language.

In some implementations, the system can provide prompts to the second machine learning model that include different queries about whether the author of the first segment is going to switch a communication channel. For example, for each prompt, the system can provide the first segment and a different query to the second machine learning model. The system can aggregate the outputs from the second machine learning model to generate one combined score representing the likelihood that the author of the first segment is hiding information.

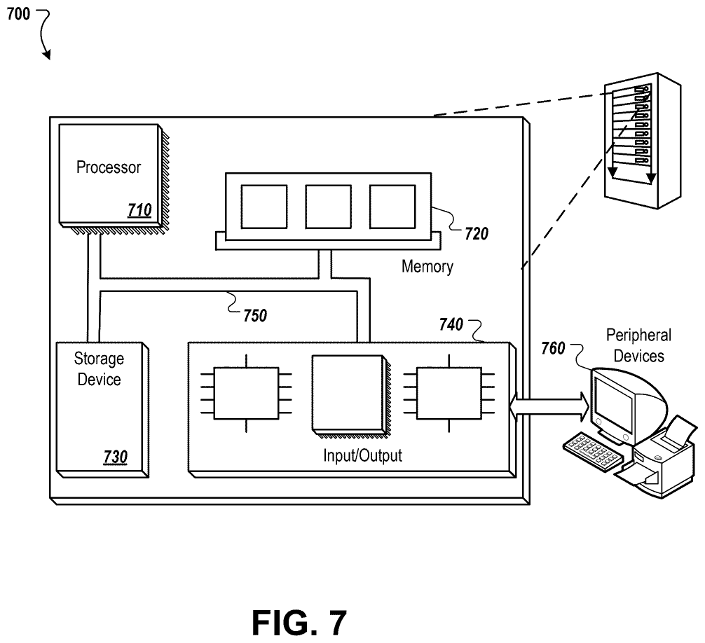

FIG. 7 depicts a schematic diagram of a computer system 700. The system 700 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 700) and their structural equivalents, or in combinations of one or more of them. The system 700 is intended to include various forms of digital computers, such as laptops, desktops, workstations, personal digital assistants, servers, blade servers, mainframes, and other appropriate computers, including vehicles installed on base units or pod units of modular vehicles. The system 700 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. The processor may be designed using any of a number of architectures. For example, the processor 710 may be a CISC (Complex Instruction Set Computers) processor, a RISC (Reduced Instruction Set Computer) processor, or a MISC (Minimal Instruction Set Computer) processor.

In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining data representing a sequence of text;
obtaining a sequence of tokens for the sequence of text comprising one or more groups of tokens, wherein each group comprises two or more tokens;
processing the one or more groups of tokens using a first machine learning model to identify tokens that are out of context in the sequence of tokens; and
providing data representing the identified tokens.

2. The method of claim 1, wherein the sequence of text represents one or more documents.

3. The method of claim 1, wherein obtaining a sequence of tokens for the sequence of text comprises providing the sequence of text as input to a model that is configured to generate a sequence of tokens given an input sequence of text.

4. The method of claim 1, wherein each group represents a sentence fragment of the sequence of text.

5. The method of claim 1, wherein processing the one or more groups of tokens using a first machine learning model to identify tokens that are out of context in the sequence of tokens comprises:
for each group in the one or more groups:
for each token in the group:
generating an input prompt for the token, wherein the input prompt comprises the two or more tokens of the group and a mask in a location of the token;
providing the input prompt to the first machine learning model, wherein the first machine learning model is configured to generate a probability distribution given one or more tokens and a mask, wherein the probability distribution comprises a respective probability that each of a plurality of tokens appears in the location of the mask, and wherein the plurality of tokens includes the tokens;
determining that the respective probability for the tokens does not meet a threshold probability; and
in response to determining that the respective probability for the token does not meet a threshold probability, identifying the token as out of context.

6. The method of claim 5, wherein the threshold probability is obtained from a user.

7. The method of claim 1, wherein processing the one or more groups of tokens using a first machine learning model to identify tokens that are out of context in the sequence of tokens comprises processing the one or more groups of tokens using the first machine learning model to identify phrases that are out of context, wherein each phrase comprises two or more consecutive tokens.

8. The method of claim 7, wherein processing the one or more groups of tokens using the first machine learning model to identify phrases that are out of context comprises:
for each group in the one or more groups:
identifying one or more phrases in the group;
for each identified phrase:
for each token in the identified phrase:
generating an input prompt, wherein the input prompt comprises the two or more tokens of the group and a mask in a location of the token;
providing the input prompt to the first machine learning model, wherein the first machine learning model is configured to generate a probability distribution given one or more tokens and a mask, wherein the probability distribution comprises a respective probability that each of a plurality of tokens appears in the location of the mask, and wherein the plurality of tokens includes the token;
determining a respective probability for the token;
determining a combined probability for the identified phrase based on the respective probabilities for the tokens in the identified phrase;
determining that the combined probability for the identified phrase does not meet a second threshold probability; and
in response to determining that the combined probability for the identified phrase does not meet the second threshold probability, identifying the identified phrase as out of context.

9. The method of claim 7, wherein identifying one or more phrases comprises identifying one or more phrases that each comprise two or more consecutive tokens and less than a maximum number of consecutive tokens.

10. The method of claim 1, wherein the first machine learning model comprises a language model that has been trained on a masked language modeling task.

11. The method of claim 10, wherein the language model comprises an encoder-based transformer.

12. The method of claim 1, further comprising identifying high-value tokens from the identified tokens.

13. The method of claim 12, wherein identifying high-value tokens from the identified tokens comprises:
for each of the identified tokens, determining a number of occurrences of the identified token in the sequence of text; and
identifying one or more identified tokens with a number of occurrences over a threshold number of occurrences as high-value tokens.

14. The method of claim 12, wherein the sequence of text represents one or more documents originating from one or more authors, and wherein identifying high-value tokens from the identified tokens comprises:
obtaining one or more authors of interest from the one or more authors;
for each of the identified tokens, determining a corresponding set of authors for the identified token; and
identifying one or more identified tokens with a corresponding set of authors that includes at least one of the one or more authors of interest as high-value tokens.

15. A method comprising:
obtaining data representing a sequence of text;
dividing the sequence of text into a plurality of segments, wherein each segment comprises a plurality of words or subwords that are semantically relevant;
processing the plurality of segments using a second machine learning model to identify segments that include surreptitious language; and
providing data representing the identified segments.

16. The method of claim 15, wherein processing the plurality of segments using a second machine learning model to identify segments that include surreptitious language comprises:
for each segment of the plurality of segments:
providing the segment to the second machine learning model, wherein the second machine learning model is configured to generate a score representing a likelihood that an input segment of text includes language that indicates an author of the segment is hiding information;
determining that the score for the segment meets a threshold score; and
in response to determining that the score for the segment meets the threshold score, identifying the segment as including surreptitious language.

17. The method of claim 15, wherein processing the plurality of segments using a second machine learning model to identify segments that include surreptitious language comprises:
obtaining a timestamp for each segment in the plurality of segments;
determining a temporally ordered sequence of segments for the plurality of segments based on the timestamps for each segment;
for each consecutive pair of segments in the temporally ordered sequence:
determining an interval of time elapsed between a first segment of the consecutive pair of segments and a second segment of the consecutive pair of segments;
determining that the interval of time meets a threshold interval of time;
in response to determining that the interval of time meets the threshold interval of time,
providing the first segment to the second machine learning model, wherein the second machine learning model is configured to generate a score representing a likelihood that an input segment of text includes language that indicates an author of the segment is hiding information;
determining that the score for the first segment meets a threshold score; and
in response to determining that the score for the first segment meets the threshold score, identifying the first segment as including surreptitious language.

18. The method of claim 17, wherein the threshold interval of time is determined based on an average interval of time elapsed between consecutive segments in the temporally ordered sequence of segments.

19. A system comprising:
obtaining data representing a sequence of text;
obtaining a sequence of tokens for the sequence of text comprising one or more groups of tokens, wherein each group comprises two or more tokens;
processing the one or more groups of tokens using a first machine learning model to identify tokens that are out of context in the sequence of tokens; and
providing data representing the identified tokens.

20. One or more computer-readable storage media storing instructions that when executed by one or more computers cause the one or more computers to perform operations comprising:
obtaining data representing a sequence of text;
obtaining a sequence of tokens for the sequence of text comprising one or more groups of tokens, wherein each group comprises two or more tokens;
processing the one or more groups of tokens using a first machine learning model to identify tokens that are out of context in the sequence of tokens; and
providing data representing the identified tokens.
